(19) United States
(12) Patent Application Publication
(10) Pub. No.: US 2016/0115799 A1
(43) Pub. Date: Apr. 28, 2016

(54) METHOD OF FORMING TURBULATORS ON A TURBOMACHINE SURFACE AND APPARATUS

(71) Applicant: General Electric Company, Schenectady, NY (US)

(72) Inventors: Dechao Lin, Greer, SC (US); Wei Chen, Greer, SC (US); Xiaoxue Diao, Greenville, SC (US); Paul Stephen Dimascio, Greer, SC (US); Srikanth Chandrudu Kottilingam, Simpsonville, SC (US); Brian Lee Tollison, Honea Path, SC (US)

(21) Appl. No.: 14/522,824

(22) Filed: Oct. 24, 2014

(51) Int. Cl. F01D 9/02; F23R 3/00; B23K 9/16; F23R 3/02

(52) U.S. Cl. CPC F01D 9/02; F23R 3/02; F23R 3/005; F23R 3/002; B23K 9/16; F05D 2230/235; F05D 2240/127; F05D 2230/31

(57) ABSTRACT

A method of forming a plurality of turbulators on a turbomachine surface includes depositing a portion of material on the turbomachine surface forming a first portion of the plurality of turbulators, adding additional material to the first portion, and establishing a desired dimension of the plurality of turbulators.

### BACKGROUND OF THE INVENTION

The subject matter disclosed herein relates to the art of turbomachines and, more particularly, to a method of forming turbulators on a turbomachine surface.

Turbomachine systems typically include a turbomachine coupled to an intake system and a load. The turbomachine typically includes a compressor portion and a turbine portion. An airstream passes through the intake system into the compressor portion. The compressor portion forms a compressed air stream that is introduced into the turbine portion. In a gas turbomachine, a portion of the compressed airstream mixes with products of combustion in a combustor assembly forming a hot gas stream that is introduced into the turbine portion through a transition piece. In some cases, turbomachine gases may pass over turbulators to enhance various flow and operational characteristics.

The hot gas stream flows from a transition piece fluidically connecting the combustor assembly and the turbine portion. The hot gases passing from the transition piece flow toward a first stage of the turbine portion. The hot gases flow over a first stage nozzle prior to impacting first stage rotor blades. The first stage nozzle conditions and directs the hot gases toward the first stage rotor blades. The hot gases expand through additional stages of the turbine portion, each having associated rotor blades, before passing to an exhaust system.

The rotor blades are generally connected to a wheel which, in turn, may be connected to a shaft. Typically, the shaft is operatively connected to a load. The hot gas stream imparts a force to the rotor blades causing rotation of the shaft. The rotation of the shaft is transferred to the rotor. Thus, the turbine portion converts thermal energy from the hot gas stream into mechanical/rotational energy that is used to drive the load. The load may take on a variety of forms including a generator, a pump, an aircraft, a locomotive, or the like.

### BRIEF DESCRIPTION OF THE INVENTION

According to one aspect of an exemplary embodiment, a method of forming a plurality of turbulators on a turbomachine surface includes depositing a portion of material on the turbomachine surface, forming a first portion of the plurality of turbulators, adding additional material to the first portion, and establishing a desired dimension of the plurality of turbulators.

According to another aspect of an exemplary embodiment, a turbomachine includes a compressor portion, including a compressor surface, and a turbine portion operatively connected to the compressor portion. The turbine portion includes a turbine surface. A combustor is fluidically connected to the compressor portion and the turbine portion. The combustor includes a combustor surface. At least one of the compressor surface, turbine surface, and combustor surface includes a plurality of turbulators. Each of the plurality of turbulators is formed from material deposited onto at least one of the compressor surface, turbine surface, and combustor surface.

According to yet another aspect of an exemplary embodiment, a turbomachine system includes a compressor portion including a compressor surface and a turbine portion operatively connected to the compressor portion. The turbine portion includes a turbine surface. An intake system is fluidically connected to the compressor portion. A load is operatively connected to one of the compressor portion and the turbine portion. A combustor is fluidically connected to the compressor portion and the turbine portion. The combustor includes a combustor surface. At least one of the compressor surface, turbine surface, and combustor surface includes a plurality of turbulators. Each of the plurality of turbulators is formed from material deposited onto at least one of the compressor surface, turbine surface, and combustor surface.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a turbomachine system including a turbomachine having a surface including a plurality of turbulators formed in accordance with an exemplary embodiment;

FIG. 2 depicts a combustor liner of the turbomachine of FIG. 1 including the plurality of turbulators formed in accordance with an exemplary embodiment;

FIG. 3 depicts a first portion of a turbulator formed in accordance with an exemplary embodiment;

FIG. 4 depicts a second portion of a turbulator formed in accordance with an exemplary embodiment;

FIG. 5 depicts a third portion of a turbulator formed in accordance with an exemplary embodiment; and

FIG. 6 depicts a cross-sectional view of a turbulator formed in accordance with an exemplary embodiment.

The detailed description explains embodiments of the invention, together with advantages and features, by way of example with reference to the drawings.

### DETAILED DESCRIPTION OF THE INVENTION

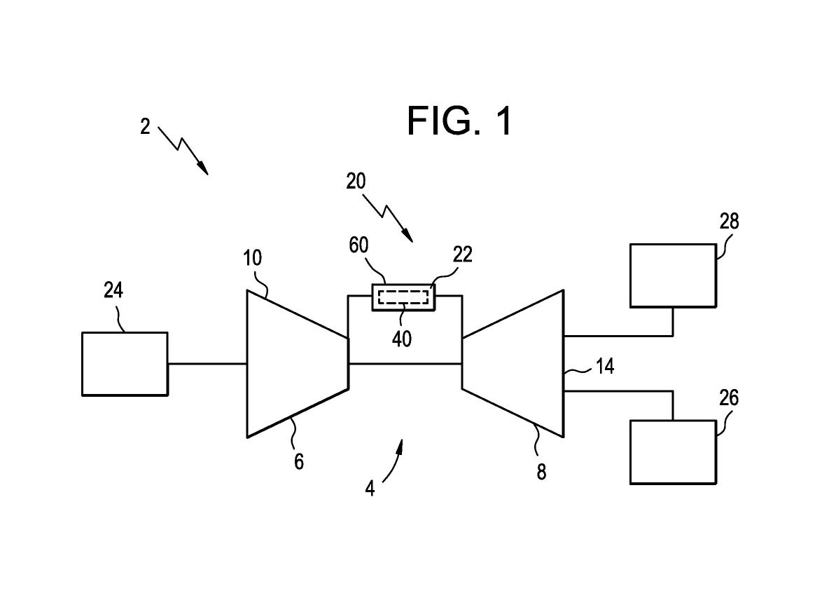

With initial reference to FIG. 1, a turbomachine system is indicated generally at 2. Turbomachine system 2 includes a turbomachine 4 having a compressor portion 6 connected to a turbine portion 8. Compressor portion 6 includes an inlet 10. Turbine portion 8 includes an outlet 14. A combustor assembly 20 fluidically connects compressor portion 6 and turbine portion 8. Combustor assembly 20 includes one or more combustors 22. Turbomachine system 2 is further shown to include an intake system 24 fluidically connected to inlet 10 and a load 26 that may be operatively connected to turbine portion 8. It should be understood that load 26 may also be connected to compressor portion 6. An exhaust system 28 is fluidically connected to outlet 14 of turbine portion 8. Exhaust system 28 receives and conditions exhaust gases passing from turbomachine 4.

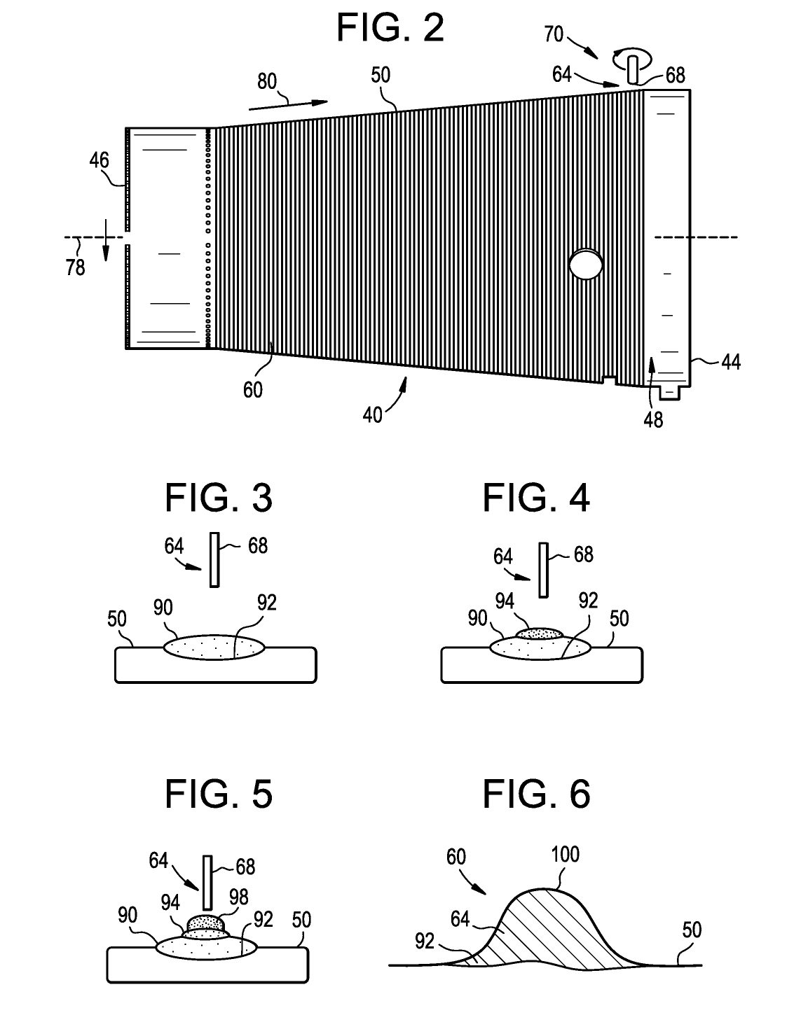

Combustor 22 includes a combustor liner 40. As shown in FIG. 2, combustor liner 40 extends from a first end 44 to a second end 46 through an intermediate portion 48 having an outer surface 50 and an inner surface (not separately labeled). In accordance with an exemplary embodiment, a plurality of turbulators, one of which is indicated at 60, are provided on outer surface 50. Turbulators 60 circumscribe combustor liner 40 and are formed from a material 64 deposited on outer surface 50. In accordance with an aspect of an exemplary embodiment, material 64 may be similar to a material used to form combustor liner 40. In accordance with another aspect of an exemplary embodiment, material 64 may be different from the material used to form combustor liner 40. More specifically, the particular type of material used to form turbulators 60 may vary depending upon desired flow conditioning characteristics. For example, a less expensive material having desirable material characteristics may be employed to realize a cost savings.

In further accordance with an exemplary embodiment, material 64 may be embodied in a welding electrode shown as an electrically conductive wire 68 that is deposited onto outer surface 50 through a welding process. More specifically, electrically conductive wire 68 may be a consumable electrode dispensed from a welding member shown in the form of a metal-inert-gas (MIG) gun 70 positioned proximate to outer surface 50. Alternatively, material 64 may be embodied in a non-consumable electrode such as TIG or plasma arc welding. In still further accordance with an aspect of an exemplary embodiment, combustor liner 40 is rotated about a first axis 78 while material 64 is deposited onto outer surface 50. After forming one of the plurality of turbulators 60, MIG gun 70 translates, along a second axis 80, to form another of the plurality of turbulators 60, as will be detailed more fully below. Second axis 80 is angled relative to first axis 78 and generally follows an outer profile (not separately labeled) of combustor liner 40.

As shown in FIG. 3, turbulator 60 is formed by initially depositing a first portion 90 or pool of material 64 onto outer surface 50 forming a fusion interface or bond 92. A second portion 94 may be added or deposited onto first portion 90, forming a combined pool of material, as shown in FIG. 4. Of course, it should be understood that second portion 94 may not be needed depending upon a desired dimension of turbulator 60. FIG. 5 depicts a third portion or pool 98 of material 64 being combined with first portion 90 and second portion 94 to form turbulator 60. In accordance with an exemplary embodiment, turbulator 60 is formed by combining one or more molten pools of material and includes a curvilinear profile 100, as shown in FIG. 6. In the embodiment shown in FIG. 6, turbulator 60 may include a height of between about 0.025-inch to about 0.06-inch and a width of about 0.030-inch to about 0.150-inch. Further, curvilinear profile may have a contact angle of less than about 60°.

At this point it should be understood that the exemplary embodiments describe a method of adding one or more turbulators to a turbomachine surface. More specifically, in contrast to prior art processes in which material is removed or subtracted from a surface, the exemplary embodiments add material to a turbomachine surface to form one or more turbulators. The addition of material not only reduces or eliminates significant waste formed when employing machining techniques, but also reduces manufacturing time. Further, by adding material, the turbulators may be formed having a number of geometries previously unattainable, in a cost effective manner, through subtractive processes such as machining. It should also be appreciated that the number, size, shape and pattern of the turbulators may vary. For example, turbulator dimensions may vary depending on desired heat transfer characteristics. Further, while shown as being added to an outer surface of a combustor liner, turbulators may be formed on virtually any turbomachine surface including compressor surfaces and turbine surfaces.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of forming a plurality of turbulators on a turbomachine surface comprising:
depositing a portion of material on the turbomachine surface forming one of the plurality of turbulators.

2. The method of claim 1, further comprising:
adding additional material to the portion of material; and
establishing a desired dimension of the plurality of turbulators.

3. The method of claim 1, wherein establishing a desired dimension of the plurality of turbulators includes forming a curvilinear profile for each of the plurality of turbulators.

4. The method of claim 1, wherein depositing material on the turbomachine surface includes adding material to a combustor liner.

5. The method of claim 1, wherein depositing material on the turbomachine surface includes translating the turbomachine surface along a first axis relative to a welding member.

6. The method of claim 5, wherein translating the turbomachine surface along the first axis includes rotating the turbomachine surface.

7. The method of claim 5, further comprising: translating the welding member along a second axis distinct from the first axis.

8. The method of claim 7, wherein translating the welding member along the second axis includes moving the welding member along the second axis angled relative to the first axis.

9. The method of claim 1, wherein depositing material on the turbomachine surface includes directing a welding electrode toward the turbomachine surface.

10. The method of claim 1, wherein adding the additional material to the portion of material includes forming another portion of each of the plurality of turbulators that is smaller than the portion of material.

11. The method of claim 10, further comprising: adding a third portion to each of the plurality of turbulators that is smaller than the second portion.

12. The method of claim 1, wherein depositing material on the turbomachine surface includes depositing a material that is distinct from a material forming the turbomachine surface.

13. A turbomachine comprising:
a compressor portion including a compressor surface;
a turbine portion operatively connected to the compressor portion, the turbine portion including a turbine surface; and
a combustor fluidically connected to the compressor portion and the turbine portion, the combustor including a combustor surface,
wherein at least one of the compressor surface, turbine surface, and combustor surface includes a plurality of turbulators, each of the plurality of turbulators being formed from material deposited onto at least one of the compressor surface, turbine surface, and combustor surface.

14. The turbomachine according to claim 13, wherein each of the plurality of turbulators includes a curvilinear profile.

15. The turbomachine according to claim 13, wherein each of the plurality of turbulators is formed from a material that is distinct from a material forming the at least one of the compressor surface, turbine surface, and combustor surface.

16. The turbomachine according to claim 13, wherein each of the plurality of turbulators is formed from a one or more layers deposited onto the at least one of the compressor surface, turbine surface, and combustor surface.

17. A turbomachine system comprising:
a compressor portion including a compressor surface;
an intake system fluidically connected to the compressor portion;
a turbine portion operatively connected to the compressor portion, the turbine portion including a turbine surface;
a load operatively connected to one of the compressor portion and the turbine portion; and
a combustor fluidically connected to the compressor portion and the turbine portion, the combustor including a combustor surface,
wherein at least one of the compressor surface, turbine surface, and combustor surface includes a plurality of turbulators, each of the plurality of turbulators being formed from material deposited onto at least one of the compressor surface, turbine surface, and combustor surface.

18. The turbomachine system according to claim 17, wherein each of the plurality of turbulators includes a curvilinear profile.

19. The turbomachine system according to claim 17, wherein each of the plurality of turbulators is formed from a material that is distinct from a material forming the at least one of the compressor surface, turbine surface, and combustor surface.

20. The turbomachine system according to claim 17, wherein each of the plurality of turbulators is formed from a one or more layers deposited onto the at least one of the compressor surface, turbine surface and combustor surface.
